(19) United States
(12) Patent Application Publication
(10) Pub. No.: US 2004/0022060 A1
(43) Pub. Date: Feb. 5, 2004

(54) Light-fixture shade-assembly mounting apparatus

(75) Inventor: Casey Chung, Bloomingdale, IL (US)

Correspondence Address: BANNER & WITCOFF, LTD., TEN SOUTH WACKER DRIVE, SUITE 3000, CHICAGO, IL, 60606, US

(73) Assignee: Focal Point LLC, Chicago, IL (US)

(21) Appl. No.: 10/210,482

(22) Filed: Aug. 1, 2002

(51) Int. Cl. F21V 1/06

(52) U.S. Cl. 362/352; 362/351; 362/353; 362/354

(57) ABSTRACT

A light-fixture shade-assembly mounting apparatus is operatively coupled to a light fixture via a plurality of coupling members, such as hinged limbs. A hinged limb may be coupled to a shade-assembly via a peg inserted through a bore. A locking mechanism may secure the shade assembly into a normal-operation position and may allow the shade assembly to be lowered into a bulb-replacement position. The locking mechanism may include a locking cam having an angled surface so that, as the locking cam engages a portion of the light fixture and rotates, the inclined surface of the locking cam will cause the position of the shade assembly to become higher or lower with respect to the light fixture. The locking mechanism may include a visual indication, such as an arrow, which allows a person to determine the locking cam's orientation relative to a locked position and an unlocked position.

### TECHNICAL FIELD

The invention relates generally to light fixtures and more specifically to an apparatus for mounting a shade-assembly to a light fixture.

### BACKGROUND OF THE INVENTION

Conventional light fixtures typically do not provide a robust mechanism for supporting the light fixture's shade assembly while replacing the fixture's light bulbs.

For instance, a cable attached to the fixture and to the shade assembly may be used for holding the shade-assembly below the light fixture during bulb replacement. This type of arrangement imposes a practical limit on the size of the shade assembly that can be conveniently handled. For instance, a cable-type arrangement may work reasonably well for light fixtures having an area up to four square feet. But such an arrangement will typically not provide adequate support during bulb replacement for a shade-assembly of a larger light fixture, such as a light fixture having an area of 16 square-feet. Unless it is adequately supported and guided when being moved from a normal-operation position to a bulb-replacement position, a shade for a large light fixture of this type may be relatively cumbersome.

For at least the foregoing reasons, an improved apparatus for guiding and supporting a light fixture's shade assembly during bulb replacement would be desirable.

### SUMMARY OF THE INVENTION

In accordance with an illustrative embodiment of the invention, a light-fixture shade-assembly mounting apparatus is disclosed for guiding the movement of and for holding a light fixture's shade assembly out of the way while replacing the fixture's light bulbs. The inventive shade-assembly mounting apparatus is suitable for use with relatively large light fixtures and shade assemblies, for instance, a light fixture measuring four feet by four feet.

In accordance with an illustrative embodiment of the invention, a shade assembly may be operatively coupled to a light fixture via a plurality of coupling members, such as hinged limbs, which may guide the shade assembly's movement and which may support the shade assembly during bulb replacement.

A hinged limb may be coupled to a shade-assembly via a peg inserted through a bore. A clip may also be used to prevent the peg from being unintentionally removed from the bore.

A locking mechanism, in accordance with an illustrative embodiment of the invention, may be used for securing the shade assembly into a normal-operation position, when the locking mechanism is in the locked position. When the locking position is in an unlocked position, the shade assembly can be lowered into a bulb-replacement position.

The locking mechanism may include a locking cam and a locking-cam shaft that fit together with a comer piece of the shade assembly. The locking cam may have an angled surface so that, as the locking cam engages a portion of the light fixture and rotates, the inclined surface of the locking cam will cause the position of the shade assembly to become higher or lower with respect to the light fixture. In this way, the locking cam may be rotated in either direction to adjust the height of the shade assembly with respect to the light fixture.

The locking mechanism may include a visual indication, such as an arrow, which allows a person to determine the locking cam's orientation relative to a locked position and an unlocked position.

Additional features and advantages of the invention will be apparent upon reviewing the following detailed description.

### BRIEF DESCRIPTION OF THE DRAWINGS

FIG. 1 is a perspective view of a light fixture with a shade assembly in a normal-operation position in accordance with an illustrative embodiment of the invention.

FIG. 2 is a perspective view of a light fixture with a shade assembly lowered into a bulb-replacement position in accordance with an illustrative embodiment of the invention.

FIG. 3 is an assembly view of a shade-assembly corner piece and locking mechanism in accordance with an illustrative embodiment of the invention.

FIGS. 4A-4C are perspective side, bottom, and up-side-down views of a locking cam with an angled surface in accordance with an illustrative embodiment of the invention.

FIGS. 5A-5C are perspective views of a comer piece with a locking mechanism in a locked orientation, an intermediate orientation, and an unlocked orientation in accordance with an illustrative embodiment of the invention.

FIG. 6 is an enlarged view of a locking cam engaging a portion of a light fixture in accordance with an illustrative embodiment of the invention.

FIGS. 7A and 7B are perspective views of a hinged limb in a retracted orientation in accordance with an illustrative embodiment of the invention.

FIGS. 8A and 8B are perspective views of a hinged limb in an extended orientation in accordance with an illustrative embodiment of the invention.

FIG. 9 shows a corner piece of a shade assembly before being coupled to a hinged limb via a peg inserted through a bore.

FIG. 10 shows a peg, clip, and bore for coupling a hinged limb to a shade assembly in accordance with an illustrative embodiment of the invention.

FIG. 11 shows a shade assembly coupled to a hinged limb in accordance with an illustrative embodiment of the invention.

### DETAILED DESCRIPTION OF THE INVENTION

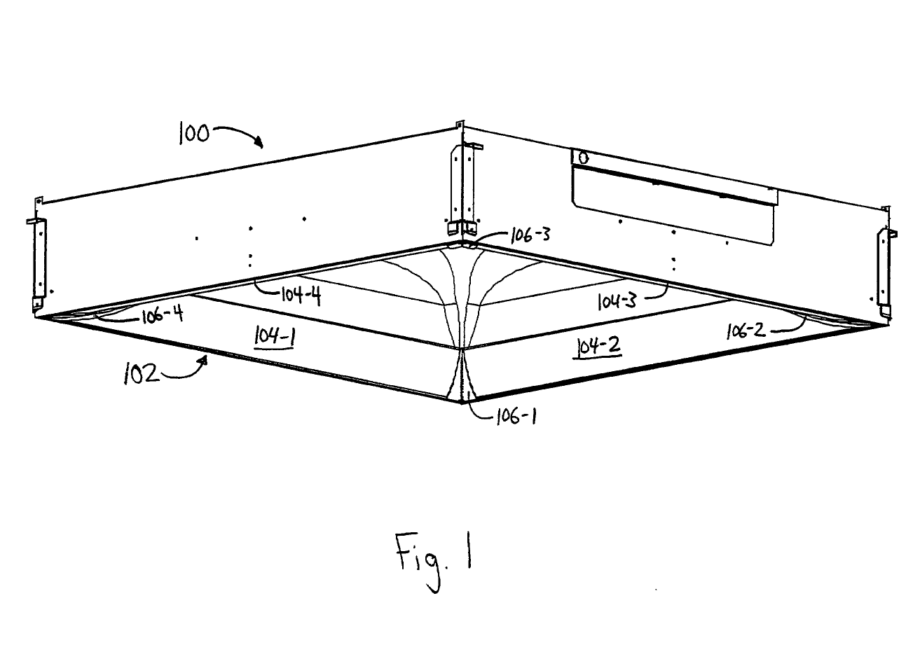

FIG. 1 depicts a light fixture 100 in accordance with an illustrative embodiment of the invention. A shade assembly 102 includes four shade panels 104-1 through 104-4 and four corner pieces 106-1 through 106-4. In FIG. 1, the shade assembly 102 is shown in the normal-operation position.

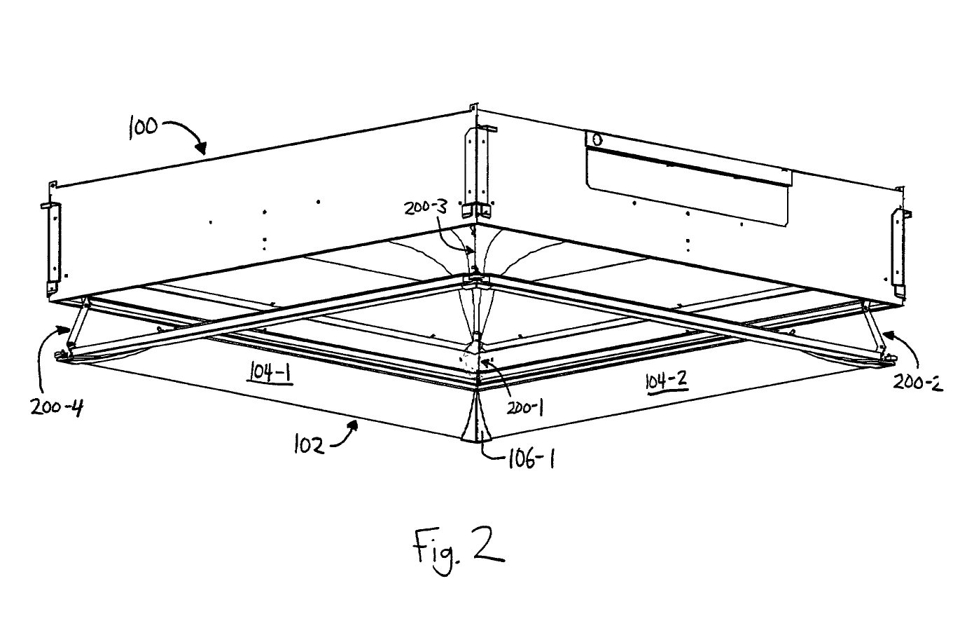

FIG. 2 depicts the light fixture 100 of FIG. 1 with the shade assembly 102 lowered to a bulb-replacement position. The shade assembly 102 may be operatively coupled to the light fixture 100 via a plurality of coupling members, such as hinged limbs 200-1 through 200-4, which may guide the shade assembly's movement and which may support the shade assembly during bulb replacement.

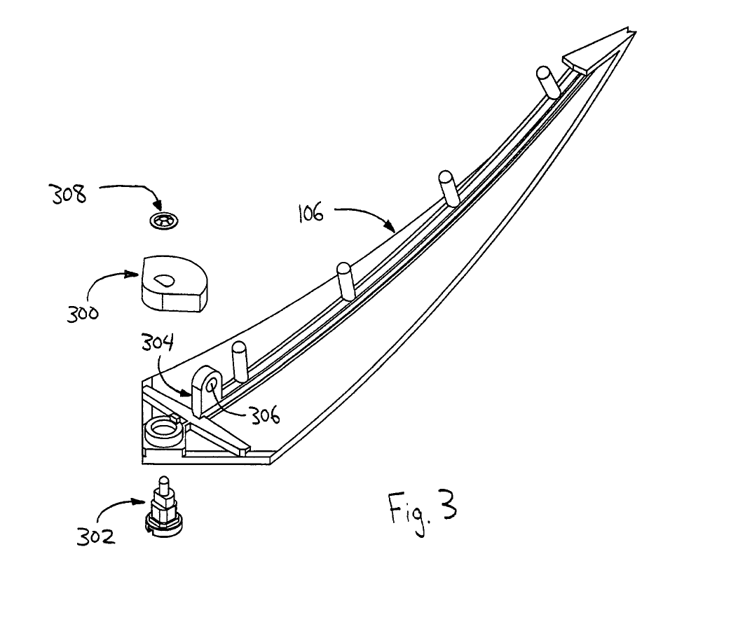

FIG. 3 is an assembly view showing how a locking cam 300 and a locking-cam shaft 302 fit together with a comer piece 106 in accordance with an illustrative embodiment of the invention. A fastener, such as clip 308, may be used to keep the locking cam 300 operatively coupled to the locking-cam shaft 302. A projection 304 includes a bore or hole 306 which may be used for coupling the corner piece 106 to a coupling member 200 as described in more detail below.

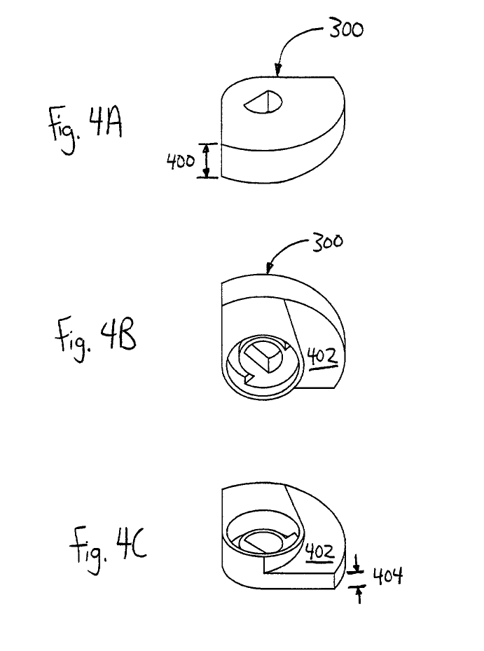

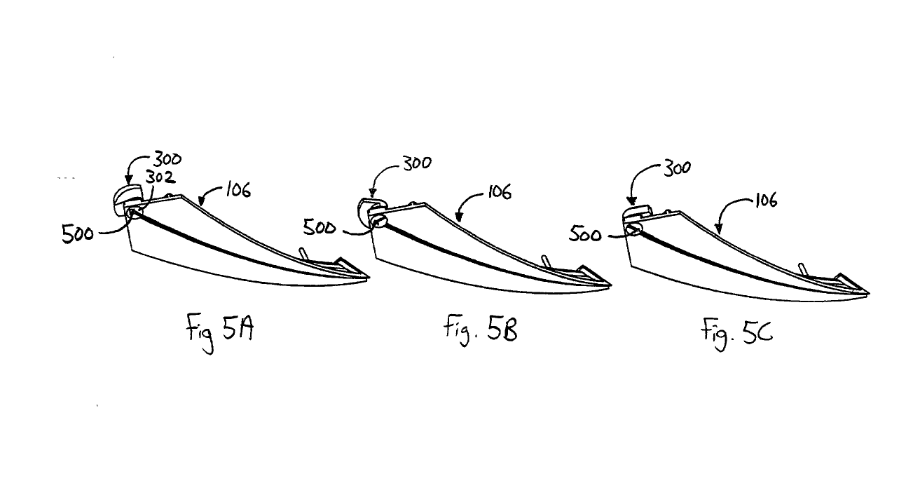

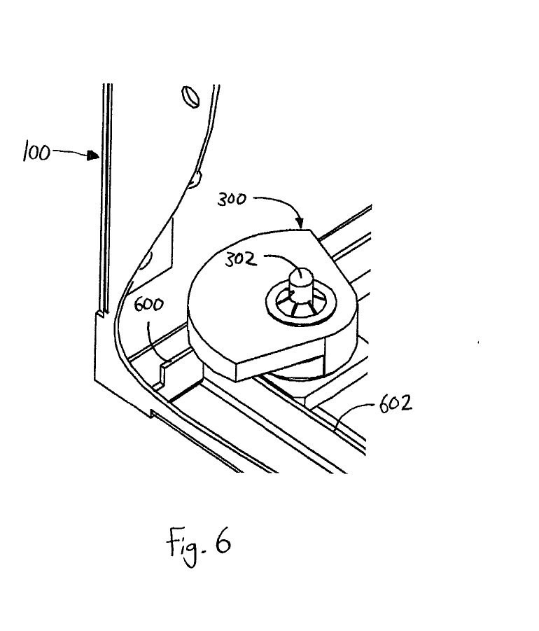

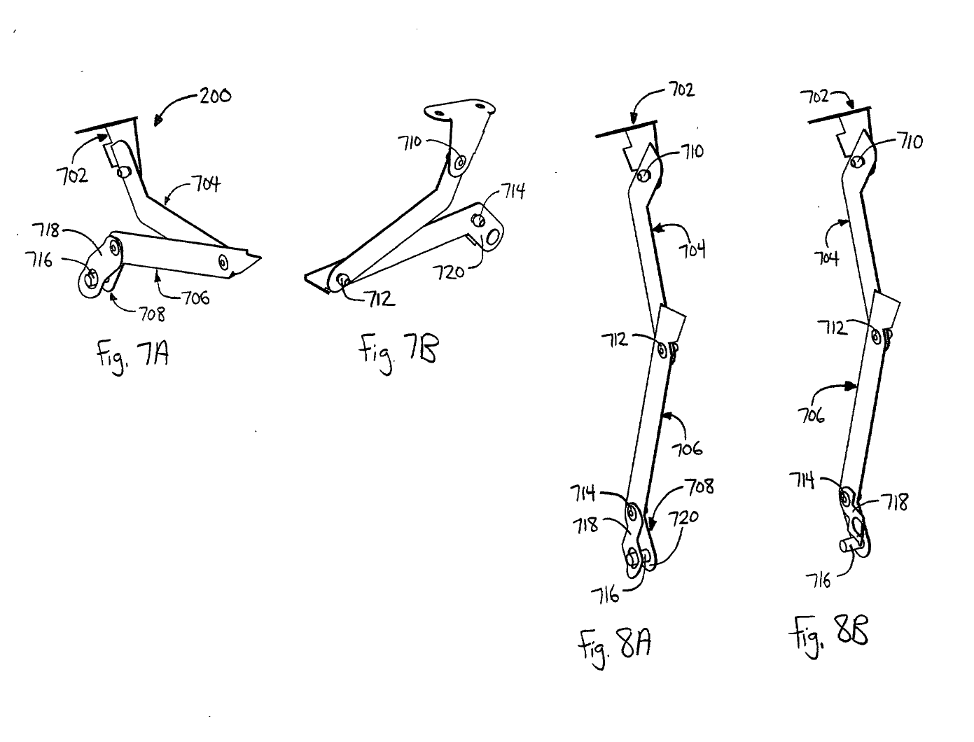

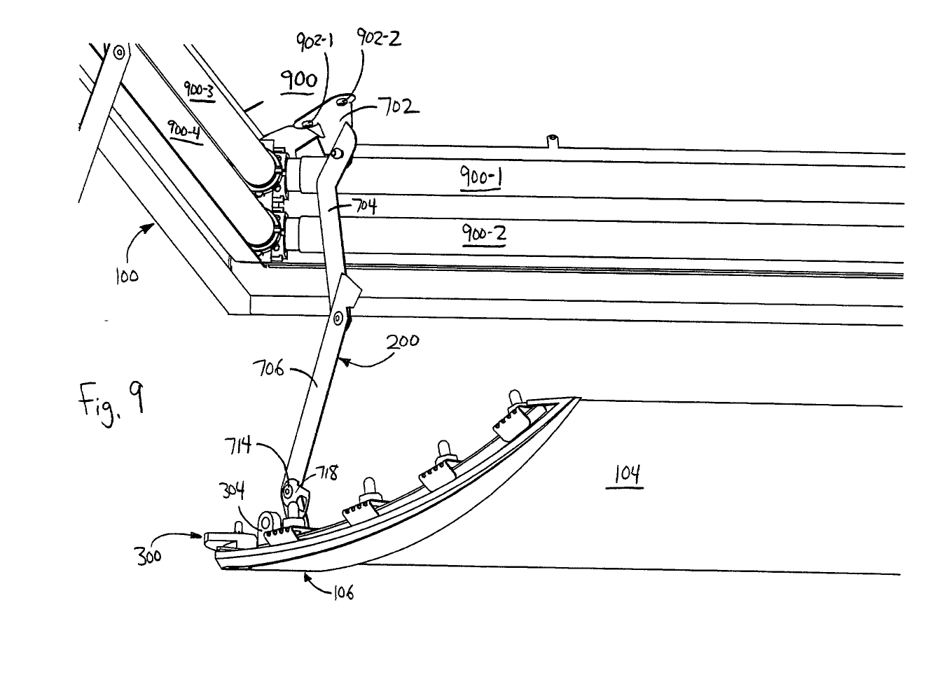

FIG. 4A is a side elevational view of a locking cam 300. The locking cam 300 has an angled surface 402. Accordingly, the height of the locking cam tapers from a larger value 400 to a smaller value 404 as shown in FIGS. 4A through 4C.

FIGS. 5A through 5C depict a locking-cam assembly including the locking-cam shaft 302 and the locking cam 300 in a locked, intermediate, and unlocked orientation, respectively. A visual indication, such as an arrow 500, allows a person to determine a locking cam's orientation relative to the locked and unlocked positions. Such a visual indication may be advantageous in circumstances in which the shade assembly 102 is in the normal-operation position and the light fixture 100 obscures a person's view of the locking cam 300.

FIG. 6 depicts a locking cam 300 engaging a portion of the light fixture 100, namely, upwardly facing surfaces 600 and 602. As the locking cam 300 rotates in a clockwise direction, as viewed in FIG. 6, the inclined surface 402 of the locking cam 300 interacts with surfaces 600 and/or 602 to cause the position of the shade assembly 102 to become lower with respect to the light fixture 100. In this way, the locking cam 300 may be rotated in either direction to adjust the height of the shade assembly 102 with respect to the light fixture 100 while the shade assembly 102 is in the normal operation position. For example, with the locking cam 300 oriented as shown in FIG. 5B, the shade assembly will be lower than when the locking cam is oriented as shown in FIG. 5A. Upon rotating the locking cam 300 to the position shown in FIG. 5C, the locking cam 300 will no longer engage the surfaces 600 and 602, and the shade assembly 102 may then be lowered for bulb replacement.

FIGS. 7A and 7B are perspective views of a retracted hinged limb 200 in accordance with an illustrative embodiment of the invention. The hinged limb 200 includes a light-fixture attachment member 702, an upper limb portion 704, and a lower limb portion 706, which includes a shade-assembly attachment member 708. The hinged limb 200 also includes an upper hinge 710 and a lower hinge 712, which rotate when the hinged limb 200 moves between its retracted position (as shown in FIGS. 7A and 7B) and its extended position (as shown in FIGS. 8A and 8B). Referring to FIGS. 8A and 8B, the shade-assembly attachment member 708 includes a distal end 720 of the lower limb portion 706, a cylindrical peg 716 projecting perpendicularly from the distal end 720, and a clip 718.

FIG. 9 shows a corner piece of a shade assembly before being coupled to a hinged limb via a peg inserted through a bore. Light bulbs 900-1 through 900-4 are shown in FIG. 9. Clip 718 is shown rotated around hinge 714 into an unclipped position in FIG. 9. The light-fixture attachment member 702 of the hinged limb 200 is shown coupled by a pair of fasteners 902-1 and 902-2 to a reflector 900 of the light fixture 100. As will be apparent, the hinged limb 200 may be coupled to other suitable parts of the light fixture.

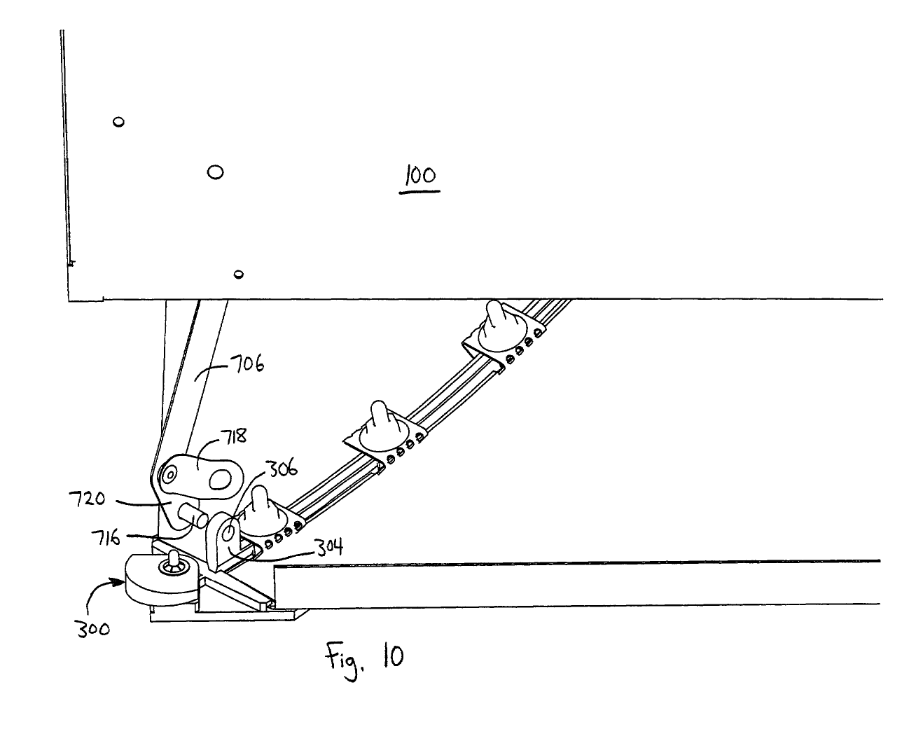

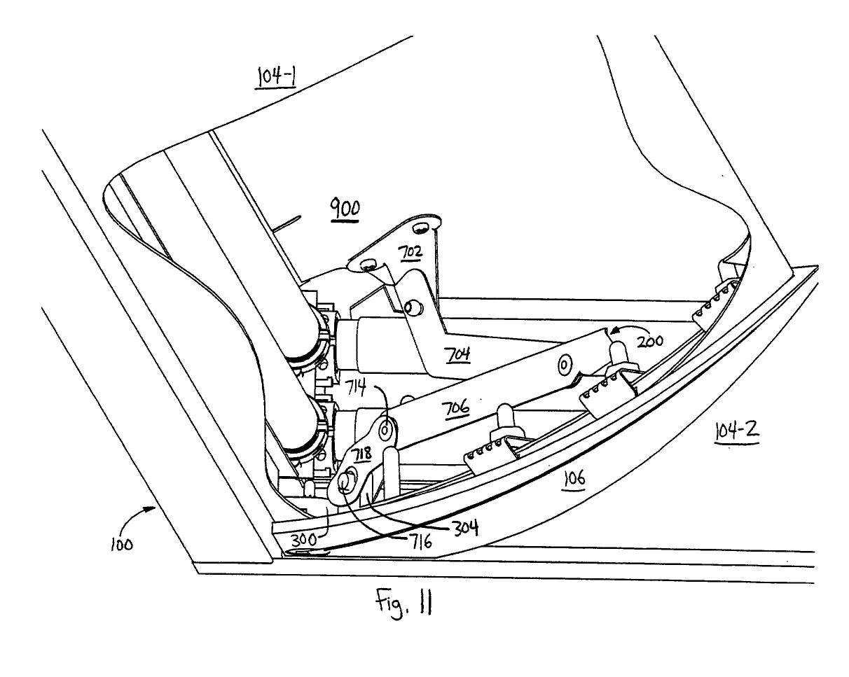

Referring to FIG. 10, to operatively couple the hinged limb 200 to the comer piece 106 of the shade assembly 102, the peg 716 may be inserted through the bore 306 of the tab 304 of the comer piece 106. The clip 718 may then be rotated around the hinge 714 from an unclipped position (as shown in FIG. 10) so that the clip prevents the peg 716 from being unintentionally removed from the hole 306 of the projection 304.

FIG. 10 shows a comer piece 106 and shade panels 104-1 and 104-2 in a normal-operating position with locking cam 300 oriented in a locking position, as shown in FIG. 5A, engaging a portion of the light fixture 100. The hinged limb 200 in FIG. 11 is shown in a retracted position with peg 716 inserted through the bore of projection 304. Clip 718 is shown in FIG. 11 rotated around hinge 714 (relative to how the clip 718 is shown in FIG. 10) into a clipped position over peg 716.

The foregoing description is illustrative of various inventive principles. Those skilled in the art can implement other arrangements without departing from the spirit and scope of the invention as set forth in the appended claims and their equivalents.

I claim:

1. A shade-assembly mounting apparatus for operatively coupling a shade assembly to a light fixture, the shade-assembly mounting apparatus comprising:
a plurality of hinged limbs that operatively couple the shade assembly to the light-fixture and that guide the shade assembly's path of travel between a normal-operation position and a bulb-replacement position; and
a plurality of pegs inserted through a plurality of corresponding bores that couple the shade-assembly mounting apparatus to the shade assembly.

2. The shade-assembly mounting apparatus of claim 1, further comprising a locking mechanism having a locked orientation and an unlocked orientation such that, in the locked orientation, the locking mechanism secures the shade assembly in the normal-operation position and, in the unlocked orientation, the locking mechanism allows the shade assembly to move from the normal-operation position to the bulb-replacement position, wherein the locking mechanism includes a plurality of locking cams each having an angled surface that cooperatively engages with a portion of the light fixture to allow for adjustment of the shade assembly's position relative to the light fixture, and wherein the locking cams include a visual indication of the relative proximity of their current orientation to the locked and unlocked orientations.

3. The shade-assembly mounting apparatus of claim 1, wherein the pegs and the bores are cylindrically shaped, and wherein, when fastened to the pegs, a plurality of clips prevent the pegs from becoming unintentionally removed from the bores.

4. A shade-assembly mounting apparatus for operatively coupling a shade assembly to a light fixture, the shade-assembly mounting apparatus comprising:
a plurality of hinged limbs that operatively couple the shade assembly to the light-fixture and that guide the shade assembly's path of travel between a normal-operation position and a bulb-replacement position; and
a locking mechanism having a locked orientation and an unlocked orientation such that, in the locked orientation, the locking mechanism secures the shade assembly in the normal-operation position and, in the unlocked orientation, the locking mechanism allows the shade assembly to move from the normal-operation position to the bulb-replacement position.

5. The shade-assembly mounting apparatus of claim 4, wherein the locking mechanism includes a plurality of locking cams, which each have an angled surface that cooperatively engages with a portion of the light fixture to allow for adjustment of the shade assembly's position relative to the light fixture.

6. The shade-assembly mounting apparatus of claim 5, wherein the locking cams include a visual indication of the relative proximity of their current orientation to the locked and unlocked orientations.

7. The shade-assembly mounting apparatus of claim 4, wherein the shade-assembly mounting apparatus is coupled to the shade assembly via a plurality of pegs inserted through a plurality of corresponding bores.

8. The shade-assembly mounting apparatus of claim 7, wherein the pegs and the bores are cylindrically shaped.

9. The shade-assembly mounting apparatus of claim 7, further comprising a plurality of clips that, when fastened to the pegs, prevent the pegs from becoming unintentionally removed from the bores.

10. A shade-assembly mounting apparatus for operatively coupling a shade assembly to a light fixture, the shade-assembly mounting apparatus comprising:
a plurality of coupling members that operatively couple the shade assembly to the light-fixture; and
a locking mechanism having a locked orientation and an unlocked orientation such that, in the locked orientation, the locking mechanism secures the shade assembly in the normal-operation position and, in the unlocked orientation, the locking mechanism allows the shade assembly to move from the normal-operation position to the bulb-replacement position, wherein the locking mechanism includes a plurality of locking cams each having an angled surface that cooperatively engages with a portion of the light fixture to allow for adjustment of the shade assembly's position relative to the light fixture.

11. The shade-assembly mounting apparatus of claim 10, wherein the plurality of coupling members comprise a plurality of hinged limbs that operatively couple the shade assembly to the light-fixture and that guide the shade assembly's path of travel between a normal-operation position and a bulb-replacement position.

12. The shade-assembly mounting apparatus of claim 10, wherein the locking cams include a visual indication of the relative proximity of their current orientation to the locked and unlocked orientations.

13. The shade-assembly mounting apparatus of claim 10, wherein the shade-assembly mounting apparatus is coupled to the shade assembly via a plurality of pegs inserted through a plurality of corresponding bores.

14. The shade-assembly mounting apparatus of claim 13, wherein the pegs and the bores are cylindrically shaped.

15. The shade-assembly mounting apparatus of claim 13, further comprising a plurality of clips that, when fastened to the pegs, prevent the pegs from becoming unintentionally removed from the bores.
